(19) United States
(12) Patent Application Publication
(10) Pub. No.: US 2019/0134527 A1
(43) Pub. Date: May 9, 2019

(54) Water Treatment Equipment

(71) Applicant: YTS Science Properties Pte. Ltd., Singapore (SG)

(72) Inventors: Takashi Yabe, Tokyo (JP); Kyoko Okemoto, Tokyo (JP)

(21) Appl. No.: 15/770,721

(22) PCT Filed: Oct. 13, 2016
(86) PCT No.: PCT/JP2016/080325

§ 371 Date: Apr. 24, 2018

(30) Foreign Application Priority Data
Oct. 23, 2015 (JP) 2015-209056

(51) Int. Cl. B01D 1/14; C02F 1/04; B01D 5/00; B01D 3/34

(52) U.S. Cl. CPC B01D 1/14; C02F 1/04; B01D 5/006; B01D 5/0054; B01D 3/346; B01D 5/0003

(57) ABSTRACT

The small-sized water treatment equipment providing high water treatment efficiency without using multi-stage structure in the water treatment equipment for obtaining fresh water from raw water, including sea water.

The water treatment equipment 10 comprises the evaporation parts 11 and 12, the condenser part 13 and the heat exchanger 24, and the raw water, including sea water, being introduced within the equipment circulates between the evaporation parts 11 and 12 and the heat exchanger 24 via circulating the circulation paths 40a to 40d. Further, circulating water circulates between the condenser part 13 and the heat exchanger 24 via circulating the circulating water circulation paths 41a to 41c, being vaporized at the evaporation parts 11 and 12 and cause vapor-liquid contact in the condenser part 13 with the steam that has circulated the air flow channels 42a to 42c. The circulating water that passed the condenser part 13 and the raw water that passed the evaporation parts 11 and 12 exchange heat at the heat exchanger 24.

### CROSS REFERENCE TO RELATED APPLICATIONS AND PRIORITY CLAIM

This application is a US National Stage patent application filed under 35 U.S.C. § 371 based upon International Patent Application No. PCT/JP2016/080325 filed Oct. 13, 2016, which claims the benefit of Japanese Application 2015-209056, filed Oct. 23, 2015, the entire contents of all of which are hereby incorporated by reference as if fully set forth herein for all purposes.

### TECHNICAL FIELD

The present invention relates to a water treatment equipment, more particularly, to a water treatment equipment, which obtains condensed water by vaporizing a portion of raw water to be heated and by condensing the vaporized steam.

### BACKGROUND ART

Conventionally, this type of water treatment equipment heats and mists raw water, including sea water, inside the container, and has proposed to desalinate or purify raw water by condensing vapor, allowing vapor-liquid contact to spray-type water with the gaseous mixture of vapor and air, generated in accordance with the mist. The water treatment equipment in Patent Literature 1 is heating raw water efficiently by exchanging heat between desalinated or purified condensed water and raw water, including sea water, then by heating raw water using solar energy. Further, raw water is also heated efficiently in Patent Literature 2, by using the temperature gaps between the upstream and downstream upon collecting latent heat, generated in accordance with the equipment.

Heating energy, equivalent to the condensed latent heat, is required for obtaining condensed water in a single-stage water treatment equipment, comprising a condenser part and an evaporation part. Therefore, conventional water treatment equipment has used the multi-stage method to reduce heat energy per stage. Patent Literature 2 proposes to reduce the heat amount by using the temperature gaps between the upstream and downstream in the equipment, in addition to adopting the multi-stage method.

### SUMMARY OF INVENTION

### Technical Problem

This kind of water treatment equipment, using the multi-stage method, has an advantage of reducing the heat amount by adding more multi-stage, however the problem is that the equipment will be large, as it will require multiple decompression chambers.

The present invention has been made in view of such problems, not requiring multi-stage structure, but provides water treatment equipment with high water treatment efficiency by using exhaust heat, to be generated within the equipment, increasing heat exchange effectiveness with raw water and reducing energy required for heating raw water afterward.

### Solution to Problem

A water treatment equipment for obtaining condensed water from raw water comprising:

an evaporation part A and an evaporation part B,
each comprising a vaporization method to vaporize a portion of said raw water;
a condenser part,
comprising a condenser part flow tube, in which circulating water that circulates within said equipment circulates;
a heating apparatus that heats said raw water;
a cooling apparatus that cools said circulating water;
an air flow channel that moves among said evaporation part A and said condenser part, said condenser part and said evaporation part B, and among said evaporation parts A and B;
a heat exchange part comprising a raw water circulation pipe for said raw water to circulate and a circulating water circulation pipe to circulate said circulating water;
a circulating water circulation path, connecting said condenser part flow tube and said circulating water circulation pipe, via passing said cooling equipment; and
a raw water circulation path, connecting outlet part of said raw water circulation pipe and inlet part of said evaporation part A, outlet part of said evaporation part A and inlet part of said evaporation part B and connecting outlet part of said evaporation part B and inlet part of said raw water circulation pipe, via passing said heating apparatus;
wherein said circulating water, heated by condensed latent heat generated upon the occurrence of vapor-liquid contact of the steam vaporized from said raw water in said evaporation parts A and B and said circulating water in said condenser part, and said raw water cooled step by step by a portion being vaporized via the steps of evaporation part A and B exchange heat at said heat exchange part.

Said water treatment equipment may comprise two or more said evaporation parts and each evaporation part may be connected to said air flow channel, where vaporized steam moves, along with connecting each evaporation part to the outlet part and the following inlet part via said raw water circulation path.

Said vaporization method may have one or more rotation axis and a radially extending rotator, installed on the rotation axis, and may vaporize a portion of said raw water, which flows into said evaporation part, using the vaporization method at the same time it drops.

A water treatment equipment for obtaining condensed water from raw water comprising:

a vaporization method having one or more horizontally extending rotation axis and a radially extending rotator, installed on the rotation axis;
comprising a saucer comprising an overflow, which catches or drains said raw water, said vaporization method and at least one evaporation part, which contains a portion of vaporized said raw water accumulated in said saucer by rolling up said rotator using said vaporization method;
a condenser part,
comprising a condenser part flow tube, in which circulating water that circulates within said equipment circulates;
a heating apparatus that heats said raw water;
a cooling apparatus that cools said circulating water;
an air flow channel that each connects said evaporation part and said condenser part, said condenser part and said evaporation part;
a heat exchange part comprising a raw water circulation pipe for said raw water to circulate and a circulating water circulation pipe to circulate said circulating water;
a circulating water circulation path, connecting said condenser part flow tube and said circulating water circulation pipe, via passing said cooling equipment; and
a raw water circulation path, connecting outlet part of said raw water circulation pipe and inlet part of said evaporation part and connecting outlet part of said evaporation part and inlet part of said raw water circulation pipe, via passing said heating apparatus;
wherein said circulating water, heated by condensed latent heat generated upon the occurrence of vapor-liquid contact of the steam vaporized from said raw water in said evaporation parts and said circulating water in said condenser part, and said raw water cooled from upstream step by step by being vaporized in said evaporation parts in said vaporization method exchange heat at said heat exchange part.

Said air flow channel may include an air current formation method.

An air current or a water current may be generated in said vaporization method at the same time said raw water vaporizes by allowing angle to the plane portion of the rotation component of said rotator to be viewed diagonally from the rotation axis direction.

Said water treatment equipment may be cylindrical.

Said condenser part flow tube may include a dripping part, which drips the obtained condensed water to vertical downward.

Said dripping part may be installed, allowing the plane portion of the board of said dripping part to be in parallel to the direction of movement of the vapor, so that the vapor derived by said air flow channel can blow through said dripping part and said flow tube.

Said condenser part flow tube may have a form being bent multiple times in said condenser part and may circulate, while meandering said circulating water.

Said condenser part may include a storage chamber to catch and store the obtained condensed water.

Said heat exchange part may be arranged at the exterior of said container.

Said heat exchange part may be a plate-type heat exchanger.

Said circulating water may be fresh water.

### Advantageous Effects of Invention

According to the present invention, it does not require multi-stage structure, but can provide water treatment equipment with high water treatment efficiency by using exhaust heat, to be generated within the equipment, increasing heat exchange effectiveness with raw water and reducing energy required for heating raw water afterward.

### BRIEF DESCRIPTION OF THE DRAWINGS

FIG. 1 is a schematic diagram showing a schematic construction upon viewing the water treatment equipment from above, according to the first embodiment of the present invention;

FIG. 2 is a schematic diagram showing a construction of the water treatment equipment, according to the first embodiment of the present invention;

FIG. 3 is a side view showing a schematic construction of the evaporation part of the water treatment equipment, according to the first embodiment of the present invention;

FIG. 4 is a side view showing a schematic construction of the condenser part of the water treatment equipment, according to the first embodiment of the present invention;

FIG. 5 is a schematic diagram showing a construction of the general multi-stage water treatment equipment, separate from the water treatment equipment of the first embodiment of the present invention;

FIG. 6 is a perspective view showing a schematic construction of the evaporation part of the water treatment equipment, according to the second embodiment of the present invention.

### DESCRIPTION OF EMBODIMENTS

Hereinafter, embodiments of the present invention will be described in details, while referring to the drawings.

### First Embodiment

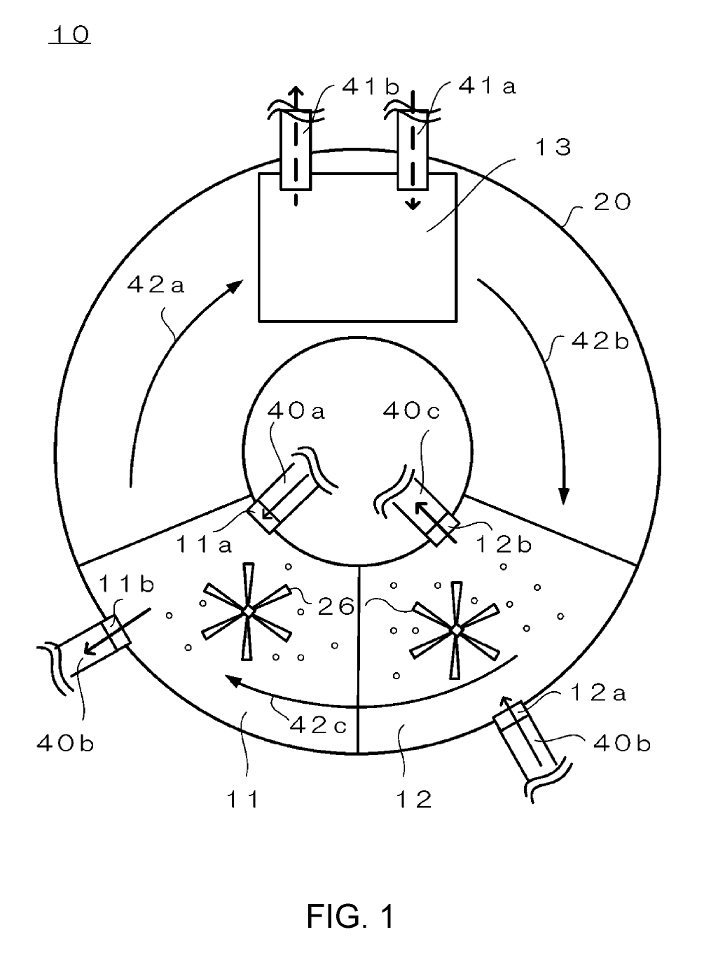

The water treatment equipment 10 is comprised as an equipment to desalinate or purify raw water, including sea water and sewage. FIG. 1 is a schematic diagram viewing the water treatment equipment 10 from above. The water treatment equipment 10 comprises the evaporation parts 11 and 12, each comprised with the vaporization method 26 for evaporating raw water inside the cylindrical container 20, and the condenser part 13 for collecting fresh water by condensing vapor.

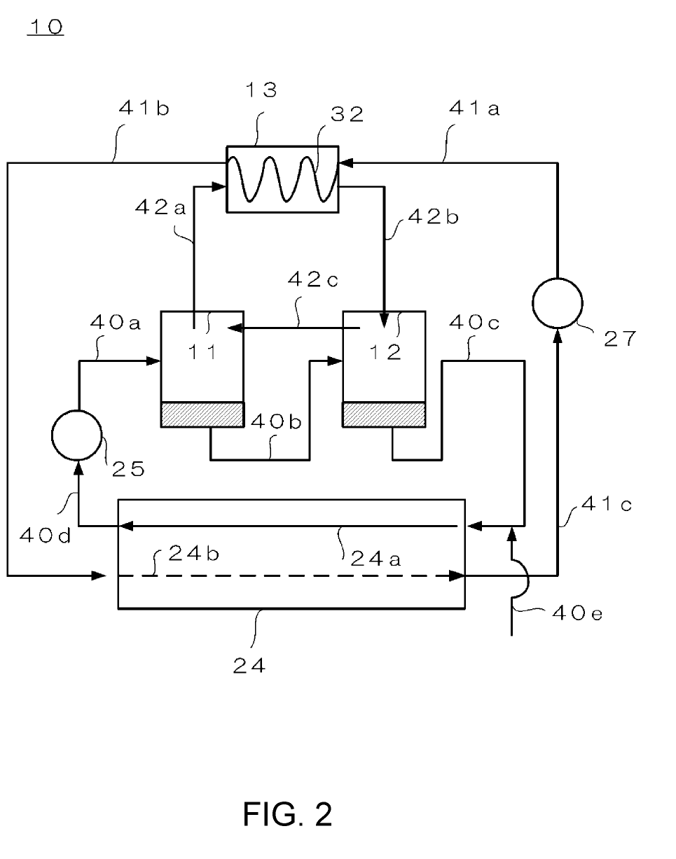

FIG. 2 is a schematic diagram showing the channels, including vapor and raw water, of the water treatment equipment 10.

The water treatment equipment 10 comprises the heat exchanger 24, which exchanges heat between raw water and circulating water that circulates within the equipment in a different channel from said raw water, the air flow channels 42a to 42c, in which the steam vaporized at the evaporation parts 11 and 12 moves, the raw water circulation paths 40a to 40d comprising heating apparatus 25 in the middle of the paths where said raw water circulates between the heat exchanger 24 and the evaporation parts 11 and 12, and the circulating water circulation paths 41a to 41c, comprising the cooling apparatus 27 in the middle of the paths where the circulating water circulates between the condenser part 13 and the heat exchanger 24, as shown in FIG. 2.

The heat exchanger 24 comprises the raw water circulation pipe 24a, in which raw water circulates, and the circulating water circulation pipe 24b, in which circulating water circulates, and raw water and circulating water that circulate them exchange heat as shown in FIG. 2. Further, the condenser part 13 comprises the circulating water flow tube 32, where circulating water circulates inside, and circulating water flowing in the flow tube 32 and the steam vaporized in the evaporation parts 11 and 12 cause vapor-liquid contact.

Circulating water flows through the circulating water circulation path 41b, connecting the outlet part from the condenser part 13 of the circulating water flow tube 32 and the inlet part to the heat exchanger 24 of the circulating water circulation pipe 24b, the circulating water circulation path 41c, connecting the outlet part from the heat exchanger 24 of the circulating water circulation pipe 24b and the cooling apparatus 27, and the circulating water circulation path 41a, connecting the cooling apparatus 27 and the inlet part to the condenser part 13 of the condenser part flow tube 32, then circulates between the condenser part 13 and the heat exchanger 24, being sent pressurized with a pump not illustrated herein. The maintenance of circulating water is easy, if such water is fresh water as an example, since fresh water has less foreign bodies, including salinity, compared to those of sea water.

Raw water flows through the raw water circulation path 40d, connecting the outlet part from the heat exchanger 24 of the raw water circulation pipe 24a and the heating apparatus 25, the raw water circulation path 40a, connecting the heating apparatus 25 and the inlet part of the evaporation part 11, the raw water circulation path 40b, connecting the outlet part of the evaporation part 11 and the inlet part of the evaporation part 12, and the raw water circulation path 40c, connecting the outlet part of the evaporation part 12 and the inlet part to the heat exchanger 24 of the raw water circulation pipe 24a, then circulates between the evaporation parts 11 and 12 and the heat exchanger 24, being sent pressurized with a pump not illustrated herein. The raw water inlet 40e to incorporate raw water, including sea water, into the water treatment equipment 10 may be comprised in the middle of the raw water circulation path 40c, which flows into the heat exchanger 24 in this case.

Steam flows through the air flow channel 42a, connecting the evaporation part 11 and the condenser part 13, the air flow channel 42b, connecting the condenser part 13 and the evaporation part 12, and the air flow channel 42c, connecting the evaporation part 12 and the evaporation part 11, then circulates between the evaporation parts 11 and 12 and the condenser part 13. Air current formation methods, including a ventilator, may be comprised in the middle of the air flow channels 42a to 42c, and steam may be circulated in this case.

The structure of the container 20 does not need to be a cylinder as in FIG. 1, as long as it is a closed circuit. It may be elliptical or rectangular, having a guide that allows air current to flow without resistance, as an example. The air can flow and circulate inside the equipment without resistance, if it is cylindrical.

A plate-type or a pipe-type heat exchanger may be used as the heat exchanger 24. The place to arrange it is optional, however, the maintenance of it will be easy by arranging the heat exchanger 24 at the exterior of the container 20.

The heating apparatus 25 heats the raw water, which has been cooled via the evaporation parts 11 and 12, and has been heated by circulating water via the heat exchanger 24 afterwards, to the temperature necessary for evaporation (at the level of 70 to 90° C., as an example) before the raw water is re-introduced in the evaporation part 11. The heating apparatus 25 may heat mediums, including water, and may heat raw water by transmitting heat indirectly from mediums. Further, the heating by the heating apparatus 25 may use solar heat, conduct by heating a heating wire or may conduct by burning or oxidizing magnesium or other elements within the mediums, as an example.

The cooling apparatus 27 cools the circulating water, which has been heated via the condenser part 13, and has been cooled via the heat exchanger 24 afterwards, to the temperature necessary for steam to condense before the circulating water is re-introduced in the condenser part 13. The cooling apparatus 27 may mix the same kind of cooled liquid as circulating water, and may extract a prescribed flow from there with a pump, as an example.

A pump sends pressurized raw water or circulating water to circulate. Well-known internal combustion engine, which obtains output power by burning fuels, or all sorts of objects, including well-known motors such as a synchronous motor or an induction motor, may be used as the driving source of a pump.

Next, the motion of the water treatment equipment 10 will be described, using FIG. 2.

The water treatment equipment 10 introduces raw water, including sea water, to the equipment from the raw water inlet 40e. The raw water introduced in the equipment circulates via the raw water introduction channels 40a to 40d between the heat exchanger 24 and the evaporation parts 11 and 12.

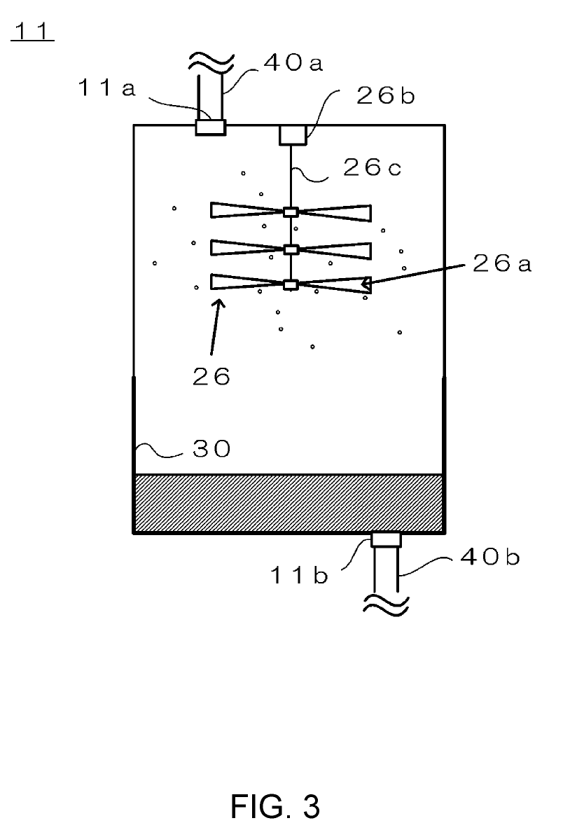

Raw water will be introduced in the evaporation part 11 from the raw water circulation path 40a and a portion of the raw water will be vaporized by the vaporization method 26. The schematic diagram of the evaporation part 11 is shown in FIG. 3. The evaporation part 11 will vaporize a portion of the raw water with the mechanical shattering due to the vaporization method 26, upon introducing raw water from the evaporation part inlet 11a. The reservoir 30, which stores raw water, is comprised at the downward of the vaporization method 26, and relatively large raindrops or raw water, which did not vaporize among the raw water that passed through the vaporization method 26, are stored inside and will be discharged from the evaporation part outlet 11b. The vaporization method 26 in FIG. 3 shows a construction of the radially extended rotator 26a, centralized by the vertically extending rotation axis 26c, being driven by the motor 26b, however, the construction of the vaporization method 26 is not limited thereto, if raw water is mechanically shattered. The rotator 26a may be installed in plurality, and the form of the rotator may be a simple disc-shape, as an example. The raw water discharged from the evaporation part 11 will be introduced in the evaporation part 12 via the raw water circulation path 40b, the heat of vaporization will be re-taken being cooled, and will be introduced in the heat exchanger 24 further being cooled upon circulating the raw water circulation path 40c.

Meanwhile, the steam vaporized from raw water at the evaporation parts 11 and 12 will circulate between the condenser part 13 and the evaporation parts 11 and 12 via the air flow channels 42a to 42c, as shown in FIG. 2. Circulating water circulates between the heat exchanger 24 and the condenser part 13 via the circulating water circulation paths 41a to 41d at the same time.

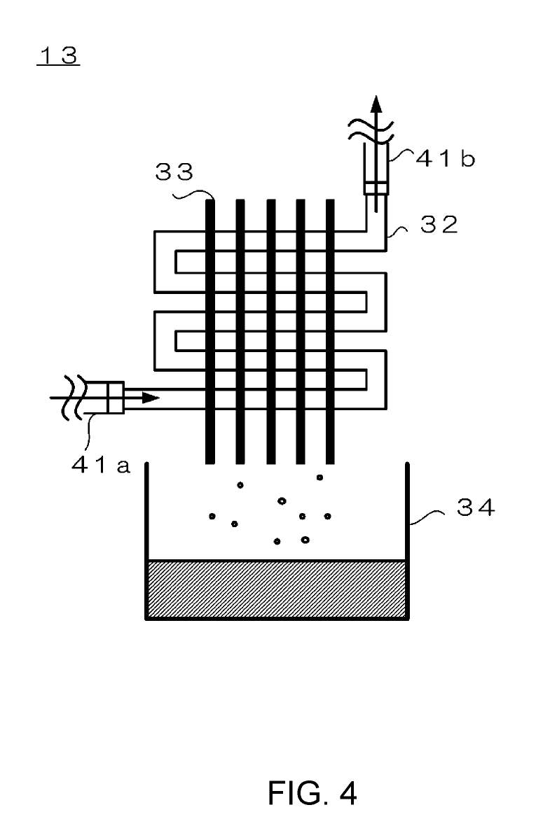

The schematic diagram of the condenser part 13 is shown in FIG. 4. The circulating water introduced in the condenser part 13 via the circulating water circulation path 41a flows through the condenser part 13 from the circulating water circulation path 41b, while circulating the water flow tube 32. The steam vaporized at the evaporation parts 11 and 12 generates condensed water by vapor-liquid contact on the surfaces of this circulating water and the circulating water flow tube 32 in that case. Condensed water drips to downward of the condenser part 13 and will be stored in the storage chamber 34. The condensed plate 33 may be installed on the circulating water flow tube 32, in a plate-type as an example, so that the condensed water drips to the storage chamber 34 by gravity in this case. The condensed plate 33 may be installed in the condenser part 13 in plurality. Circulating water has been heated by condensed heat upon circulating the circulating water circulation path 41b, then is introduced in the heat exchanger 24.

The condensed plate 33 may be installed, having prescribed space, so that the steam that flowed into the condenser part 13 via the air flow channels 42a and 42b can transit between the multiple condensed plates 33 in that case. Steam can circulate without resistance by arranging in parallel, not to disturb the direction of movement of steam, in this case. The condensed plates 33, having plane depths from the front side to the back side, are lined up in parallel with steam flowing the space in FIG. 4. Further, condensed water drips naturally to the storage chamber 34, which is located downward, along the condensed plate 33 by arranging the condensed plate 33 vertically to the storage chamber 34, which is arranged at the bottom part.

Next, the raw water, being cooled via the evaporation parts 11 and 12, and the circulating water, being heated via the condenser part 13, exchange heat at the heat exchanger 24. The raw water will be heated by the heat of the circulating water and will be heated furthermore by the heating apparatus 25, then will be re-introduced to the evaporation part 11.

The circulating water flow tube 32 may have a form being meandered multiple times in the condenser part 13, as shown in FIG. 4. More circulating water can be introduced in the condenser part 13 with this, and can improve condensed efficiency upon the transition of vapor.

Next, we will go back to FIG. 2 again and the temperature changes of raw water and circulating water in the water treatment equipment 10 will be described referring to FIG. 2.

The temperature drop ΔTc of the raw water, before and after the transition to the two evaporation parts 11 and 12, and the temperature rise ΔTv of the circulating water, before and after the transition to the condenser part 13, are the same since the steam, taking heat away from the latent heat of evaporation being vaporized in the evaporation parts 11 and 12, condense emitting the latent heat of condensation at the condenser part 13. The raw water being cooled via the second evaporation part 12 has to be heated the equivalent heat of the latent heat of condensation via the heating apparatus 25, if not having the heat exchanger 24, however, the energy necessary for heating can be reduced by collecting the latent heat of condensation in the condenser part 13 at the heat exchanger 24 and then introducing it to the heating apparatus 25 after providing the latent heat of evaporation.

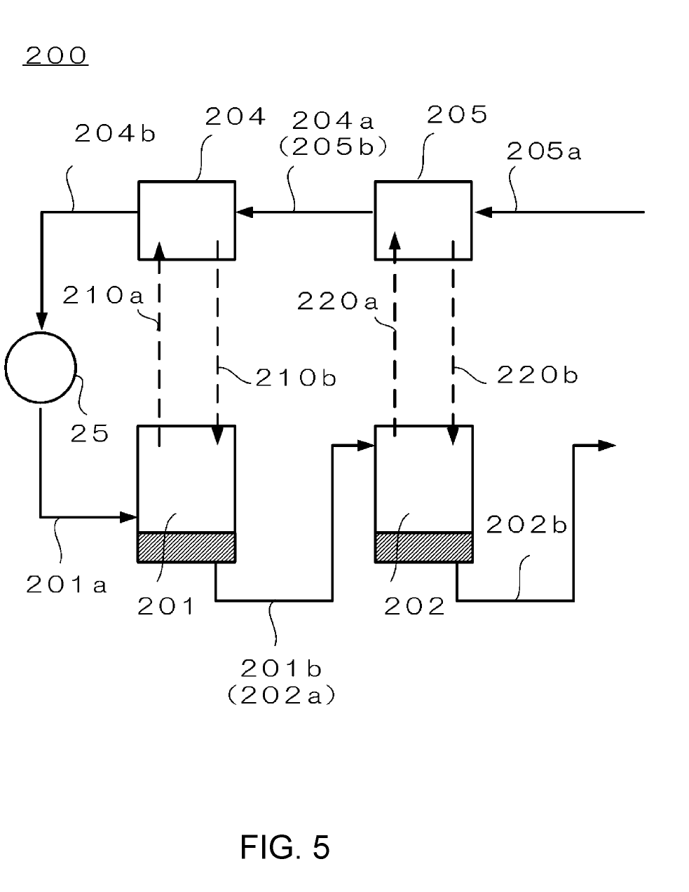

Now, this will be described specifically. Consideration will be given to the water treatment equipment 200, as shown in FIG. 5, for comparison. The water treatment equipment 200 comprises the evaporation parts 201 and 202, the condenser parts 204 and 205, the channels 201a, 201b (or 202a) and 202b, in which the heated raw water passes the evaporation parts 201 and 202 in order, the air flow channels 210a, 201b (between the evaporation part 201 and the condenser part 204), 220a and 220b (between the evaporation part 202 and the condenser part 205), in which the steam generated at this point circulates, and the channels 205a, 205b (or 204a) and 204b, in which the cooled raw water passes the condenser parts 205 and 204 in order. This means the case of a two-stage water treatment equipment with the conventional single-stage evaporation part, condenser part and a steam channel.

Considering the case of the water treatment equipment 200 being only a single-stage with the evaporation part 201, the condenser part 204 and the air flow channel 210, the raw water that transited the condenser part 204 has a temperature rise, as shown in (1). T ( ) shows the temperature of each point.

ΔT=T(204b)−T(204a) (1)

The latent heat taken away from the evaporation needs to be roughly equivalent to the latent heat of the condensation, if this is introduced in the evaporation part 201, the latent heat of the evaporation is taken away and the evaporation at this point is used for the condensation in the condenser part 204 as it is. Thus, (2) needs to be formed.

ΔT=T(201a)−T(201b) (2)

The temperature of the steam vaporized at the evaporation part is T (201)=T (201b), and this circulates, thus (3) is formed.

T(210a)=T(201b) (3)

Thus, (4) needs to be formed for the occurrence of condensation.

T(201b)=T(201a)−ΔT>T(204b) (4)

This shows that the raw water T (201b) that passed the evaporation part 201 has to be re-introduced in the evaporation part 201 after being heated ΔT or more than that of the raw water T (204b) that passed the condenser part 204, that means the latent heat of the evaporation and the heat amount are same in a single-stage, and an extremely large amount of heat amount is required for obtaining condensed water. The conventional multi-stage method is used for reducing this heat amount.

Next, we will go back to the water treatment equipment in FIG. 5 again and consider the temperature changes. There is a temperature rise (5), same as (1), in the condenser part 205.

ΔT2=T(205b)−T(205a) (5)

This will flow into the condenser part 204 as it is, thus the temperature changes before and after the transition to the condenser part 204 will be as shown in (6).

ΔT1=T(204b)−T(204a) (6)

This raw water will be heated, cooled with the vaporization at the evaporation part 201 on the first stage, and will be introduced in the evaporation part 202 on the second stage. Now, we will look into the heat amount of this time. The total condensation in this water treatment equipment 200 will be ΔT1+ΔT2. Meanwhile, (4), (7) and (8) need to be formed as well for donating to the steam vaporized at the evaporation part to condensate.

T(201b)=T(201a)−ΔT1>T(204b) (7)

T(202b)=T(202a)−ΔT2>T(205b) (8)

Now, (8) may be rewritten as shown in the following (9).

T(202b)=T(202a)−ΔT2=T(201a)−ΔT1−ΔT2>T(205b)=T(204b)−ΔT1 (9)

That means that T (201b) needs to be heated ΔT2 or more, compared to that of T (204b). T (201b) needs to be heated ΔT1 or more, compared to that of T (204b), from the formula (7), thus T (201b) needs to be heated at or higher than ΔT1 or ΔT2, whichever is higher. This means that the required heating is only half of the condensed heat, though the condensed heat is ΔT1+ΔT 2. This is the effect of the multi-stage, which enables to obtain large evaporation amount with less heating, and can obtain condensed water efficiently. While the multi-stage method has this kind of advantage, the equipment requires height with heat exchangers on each stage, thus it will be expensive.

Next, we will go back to the water treatment equipment 10 of the first embodiment of the present invention. The water treatment equipment 10, as shown in FIG. 2, is considered as the condenser parts 204 and 205 in the water treatment equipment 200, as shown in FIG. 5, being united as a single part. The temperature rise of the circulating water in the condenser part 13 in FIG. 2 will be (10).

ΔTc=T(41b)−T(41a) (10)

Meanwhile, the evaporation parts 11 and 12 will remain as two independent evaporation parts. The raw water introduced to the evaporation part 11 at T (40a) will be discharged as T (40b) due to vaporization at the evaporation part 11, and will be T (40c) due to re-vaporization at the evaporation part 12. The temperature drop at this time will be (11).

ΔTv=T(40a)−T(40c) (11)

The air vaporized by taking away the latent heat of evaporation emits the latent heat of condensation at the condenser part 13, being condensed, thus ΔTc=ΔTv is formed. Therefore, heating equivalent to the latent heat of condensation is required, as well as the previously mentioned single-stage water treatment equipment, if T (40c), which has been cooled by the steam on the second stage, needs to be heated to T (40a).

Meanwhile, the temperature drop at the evaporation part 11 will be (12).

ΔT11=T(40a)−T(40b) (12)

Therefore, T (42a)=T (40b) needs to be at a higher temperature, compared to that of T (41b), for forming condensation at the condenser part 13, thus (13) is formed.

T(40b)=T(40a)−ΔT11>T(41b) (13)

That means T (40a) needs to be ΔT11 or higher, compared to that or T (41b).

Moreover, the raw water to be discharged is T (40c) due to the temperature drop in the evaporation part 12, so this heating amount will be ΔTv, if being heated as it is, as mentioned earlier. Therefore, the heat of circulating water being heated via the condenser part 13 will be used before heating. T (40d)=T (41b) is formed with the heat exchange part 24, and since the temperature of T (41b) is equivalent to that of T (40b), temperature drop in the evaporation part 12 and heating (14) equivalent to ΔT12 is performed at the heat exchange part 24.

ΔT12=T(40b)−T(40c) (14)

This means that heating of ΔT11 from T (40b) to T (40a) by the heating apparatus 25 is only required after this, and this means that the heating of ΔT11+ΔT12=ΔTv in total is performed from T (40c). The heating temperature required for obtaining condensation equivalent to ΔTv=ΔTc, in the case of ΔT11=ΔT12, as is apparent from this, will be ΔTc/2.

Thus, the water treatment equipment having effect of reducing the heat amount as a multi-stage water treatment equipment can be provided with the single-stage structure, according to the embodiment of the present invention.

### Second Embodiment

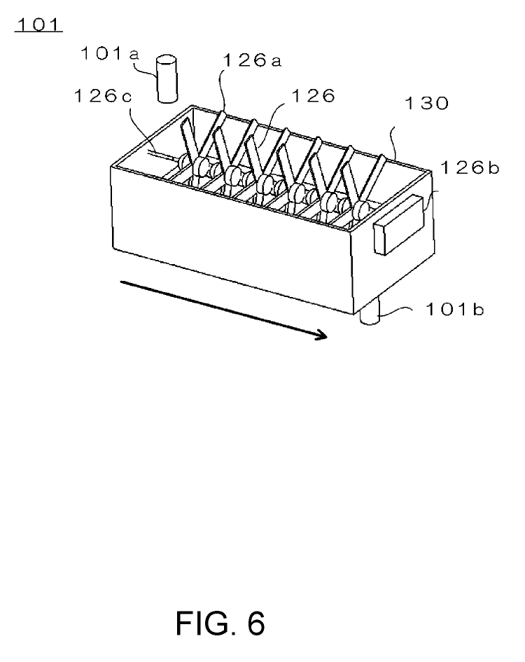

The second embodiment describes the water treatment equipment 100 with the evaporation part 101, as shown in FIG. 6, instead of the evaporation parts 11 and 12 in the first embodiment. FIG. 6 is a perspective view showing the outline of the construction of the evaporation part 101. The evaporation part 101 comprises the evaporation part inlet 101a, in which raw water is introduced, the vaporization method 126, the evaporation part outlet 101b and the reservoir 130. Further, the construction of the heat exchanger or the condenser part is same as that of the first embodiment, and duplicated description will be omitted.

The vaporization method 126 has the rotation axis 126c to be installed horizontally, the rotator 126a, which is a rotator sharing the rotation axis 126c, and the motor 126b that rotates the rotator 126a. Raw water is introduced to the evaporation part 101 from the evaporation part inlet 101a, raw water being stored gradually in the reservoir 130, and urges evaporation by rolling up raw water with the rotator 126a being rotated. Therefore, the downward of the rotator 126a is arranged to soak slightly in the stored raw water in the reservoir 130. This rotator 126a will be installed in plurality to be accommodated in the reservoir 130.

The reservoir 130 accommodates a vaporization method inside. It has length in the rotation axis direction (horizontally), stores raw water inside, and also comprises the evaporation part outlet 101b at the bottom. The raw water introduced in the evaporation part outlet 101b will be vaporized and cooled by the rotator 126a one after another, while forming natural water currents toward the evaporation part outlet 101b (toward the direction of the arrow in FIG. 6) by being installed at a position as far as possible from the evaporation part inlet 101a.

The rotator 126a may be installed in plurality in the evaporation part 101. The effect by installing the rotator 126a in plurality will be described, using FIG. 6. Raw water will be vaporized by rotating the rotator 126a and the raw water, which latent heat is taken away, is cooled flowing the natural water current heading to the evaporation part outlet 101b, flows to the neighboring rotator 126a one after another and will be cooled. Thus, by being cooled gradually from the upstream along the water current, the same effect as having multiple vaporing chambers will be obtained without requiring a channel such as the raw water circulation path 40b that circulates raw water from an evaporation part to the next evaporation part in FIG. 2. That means that the water treatment equipment that reduces energy required for heating can be provided by passing the evaporation with the multiple rotators 126a, enabling large temperature changes with a single evaporation, though not having large temperature changes.

The rotator form of the rotator 126a at this time enables circulation flow of the rotated air to form a steam air current by allowing tilt angle to the diagonal direction from the view point of the axis of rotation, as blowing wind using an electric fan, as an example. The vapor being vaporized from raw water with this air current may be sent to the condenser part via the evaporation part 101. Further, the rotator form of the rotator 126a does not need to be particular about the form as shown in FIG. 6. It may be a simple disc-shape, as an example.

The evaporation part 101, as the water treatment equipment combining the evaporation parts 11 and 12 into one part in FIG. 2, connects the evaporation part outlet 101b with the heat exchanger 24, the outlet part of the heat exchanger 24 with the heating apparatus 25, and the heating apparatus 25 with the evaporation part inlet 101a of the evaporation part 101 again, then circulates raw water.

The above has described embodiments of the present invention, the invention is not limited thereto.

### EXPLANATION OF REFERENCES

10, 100, 200
Water Treatment Equipment
11, 12, 201, 202
Evaporation Part
11a, 12a, 101a
Evaporation Part Inlet
11b, 12b, 101b
Evaporation Part Outlet
13
Condensed Part
20
Container
24
Heat Exchanger
24a
Raw Water Circulation Pipe
24b
Circulating Water Circulation Pipe
25
Heating Apparatus
26, 126
Vaporization Method
26a, 126a
Rotator
26b, 126b
Motor
26c, 126c
Rotation Axis
27
Cooling Apparatus
30, 130
Reservoir
32
Flow Tube
33
Condensed Plate
34
Storage Chamber
40a to 40d
Raw Water Circulation Path
40e
Raw Water Inlet
41a to 41c
Circulating Water Circulation Path
42a to 42c
Air Flow Channel
201a, 201b, 202a, 202b, 204a, 204b, 205a, 205b
Raw Water Channel in Water Treatment Equipment 200
210a, 210b, 220a, 220b
Air Flow Channel in Water Treatment Equipment 200

What is claimed is:

1. A water treatment equipment for obtaining condensed water from raw water comprising:
an evaporation part A and an evaporation part B,
each comprising a vaporization method to vaporize a portion of said raw water;
a condenser part,
comprising a condenser part flow tube, in which circulating water that circulates within said equipment circulates;
a heating apparatus that heats said raw water;
a cooling apparatus that cools said circulating water;
an air flow channel that moves among said evaporation part A and said condenser part, said condenser part and said evaporation part B, and among said evaporation parts A and B;
a heat exchange part comprising a raw water circulation pipe for said raw water to circulate and a circulating water circulation pipe to circulate said circulating water;
a circulating water circulation path, connecting said condenser part flow tube and said circulating water circulation pipe, via passing said cooling equipment; and
a raw water circulation path, connecting outlet part of said raw water circulation pipe and inlet part of said evaporation part A, outlet part of said evaporation part A and inlet part of said evaporation part B and connecting outlet part of said evaporation part B and inlet part of said raw water circulation pipe, via passing said heating apparatus;
wherein said circulating water, heated by condensed latent heat generated upon the occurrence of vapor-liquid contact of the steam vaporized from said raw water in said evaporation parts A and B and said circulating water in said condenser part, and said raw water cooled step by step by a portion being vaporized via the steps of evaporation part A and B exchange heat at said heat exchange part.

2. Said water treatment equipment, as stated in claim 1 comprising:
two or more said evaporation parts, each evaporation part connected to said air flow channel, where vaporized steam moves, along with connecting each evaporation part to the outlet part and the following inlet part via said raw water circulation path.

3. Said water treatment equipment, as stated either in claim 1 or claim 2 comprising:
said vaporization method having one or more rotation axis and a radially extending rotator, installed on the rotation axis, and vaporizes a portion of said raw water, which flows into said evaporation part, using the vaporization method at the same time it drops.

4. A water treatment equipment for obtaining condensed water from raw water comprising:
a vaporization method having one or more horizontally extending rotation axis and a radially extending rotator, installed on the rotation axis;
comprising said vaporization method and a saucer comprising an overflow which catches or drains said raw water, at least one evaporation part, which contains said vaporization method by rolling up said rotator to vaporize said raw water accumulated in said saucer;
a condenser part,
comprising a condenser part flow tube, in which circulating water that circulates within said equipment circulates;
a heating apparatus that heats said raw water;
a cooling apparatus that cools said circulating water;
an air flow channel that each connects said evaporation part and said condenser part, said condenser part and said evaporation part;
a heat exchange part comprising a raw water circulation pipe for said raw water to circulate and a circulating water circulation pipe to circulate said circulating water;
a circulating water circulation path, connecting said condenser part flow tube and said circulating water circulation pipe, via passing said cooling equipment; and
a raw water circulation path, connecting outlet part of said raw water circulation pipe and inlet part of said evaporation part, outlet part of said evaporation part and inlet part of said raw water circulation pipe, via passing said heating apparatus;
wherein said circulating water, heated by condensed latent heat generated upon the occurrence of vapor-liquid contact of the steam vaporized from said raw water in said evaporation parts and said circulating water in said condenser part, and said raw water cooled from upstream step by step by being vaporized in said evaporation parts in said vaporization method exchange heat at said heat exchange part.

5. Said water treatment equipment, as stated either in claim 1 to claim 4 comprising:
said air flow channel including an air current formation method.

6. Said water treatment equipment, as stated in claim 4 comprising:
an air current or a water current to be generated in said vaporization method at the same time said raw water vaporizes by allowing angle to the plane portion of the rotation component of said rotator to be viewed diagonally from the rotation axis direction.

7. Said water treatment equipment, as stated either in claim 1 to claim 6 comprising:
said water treatment equipment being cylindrical.

8. Said water treatment equipment, as stated either in claim 1 to claim 7 comprising:
said condenser part flow tube including a dripping part, which drips the obtained condensed water to vertical downward.

9. Said water treatment equipment, as stated in claim 8 comprising:
said dripping part being installed, allowing the plane portion of the board of said dripping part to be in parallel to the direction of movement of the vapor, so that the vapor derived by said air flow channel can blow through said dripping part and said flow tube.

10. Said water treatment equipment, as stated either in claim 1 to claim 9 comprising:
said condenser part flow tube having a form being bent multiple times in said condenser part which circulates, while meandering said circulating water.

11. Said water treatment equipment, as stated either in claim 1 to claim 10 comprising:
said condenser part including a storage chamber to catch and store the obtained condensed water.

12. Said water treatment equipment, as stated either in claim 1 to claim 11 comprising:
said heat exchange part to be arranged at the exterior of said container.

13. Said water treatment equipment, as stated either in claim 1 to claim 12 comprising:
said heat exchange part being a plate-type heat exchanger.

14. Said water treatment equipment, as stated either in claim 1 to claim 13 comprising:
said circulating water being fresh water.
